(19) United States
(12) Patent Application Publication
(10) Pub. No.: US 2013/0154170 A1
(43) Pub. Date: Jun. 20, 2013

(54) PASSIVE ISOLATION DEVICES PROVIDING LOW FREQUENCY DAMPING OF LOW MASS PAYLOADS AND SPACECRAFT ISOLATION SYSTEMS EMPLOYING THE SAME

(71) Applicants: Porter Davis, Phoenix, AZ (US); Steven Hadden, Peoria, AZ (US); Pablo Bandera, Avondale, AZ (US)

(72) Inventors: Porter Davis, Phoenix, AZ (US); Steven Hadden, Peoria, AZ (US); Pablo Bandera, Avondale, AZ (US)

(73) Assignee: HONEYWELL INTERNATIONAL INC., Morristown, NJ (US)

(21) Appl. No.: 13/331,512

(22) Filed: Dec. 20, 2011

(51) Int. Cl. F16F 15/04; F16F 3/00

(52) U.S. Cl. 267/136

(57) ABSTRACT

Embodiments of a low frequency isolation device are provided, as are embodiments of a spacecraft isolation system including a plurality of low frequency isolation devices. In one embodiment, the low frequency isolation device includes a three parameter isolator and a break frequency-reducing series spring mechanically coupled in series with the three parameter isolator and having a predetermined axial stiffness (K_{S AXIAL}) and a predetermined lateral stiffness (K_{S LATERAL}). The predetermined axial stiffness (K_{S AXIAL}) of the break frequency-reducing series spring is less than the predetermined lateral stiffness (K_{S LATERAL}) thereof.

### TECHNICAL FIELD

The present invention relates generally to spacecraft isolation systems and, more particularly, to passive isolation devices well-suited for damping low frequency vibrations transmitted from a spacecraft to a low mass payload.

### BACKGROUND

Control moment gyroscope arrays, reaction wheel arrays, and other such devices deployed onboard spacecraft for attitude adjustment purposes generate vibratory forces during operation. Vibration isolation systems are commonly employed to minimize the transmission of vibratory forces emitted from such attitude adjustment devices, through the spacecraft body, to any vibration-sensitive components (e.g., optical payloads) carried by the spacecraft. Vibration isolation systems commonly include a number of individual vibration isolators (typically three to eight isolators), which are positioned between the spacecraft payload and the spacecraft body in a multi-point mounting arrangement. The performance of a vibration isolation systems is largely determined by the number of isolators included within the system, the manner in which the isolators are arranged, and the vibration attenuation characteristics of each individual isolator. Vibration isolation system employing three parameter isolators, which behave mechanically as a primary spring in parallel with a series-coupled secondary spring and damper, provide superior attenuation of high frequency vibratory forces (commonly referred to as “jitter”) as compared to vibration isolation systems employing other types of passive isolators (e.g., viscoelastic isolators). An example of a three parameter isolator is the D-STRUT® isolator developed and commercially marketed by Honeywell, Inc., currently headquartered in Morristown, N.J.

A recent demand has developed for spacecraft isolation systems capable of isolating low mass payloads from low frequency vibrations, such as vibrations approaching or falling below one hertz (referred to herein as “sub-hertz vibrations”). Such low mass payloads may include, for example, laser communication systems and other optical communication devices weighing only a few pounds when grounded. It is particularly difficult, and has been widely regarded as impractical, to design a lightweight, compact, and passive isolator suitable for usage within a spacecraft isolation system that is sufficiently compliant in an axial direction (i.e., along the isolator's working axis) to provide low frequency damping of such low mass payloads, while also being relatively stiff in radial directions to maintain the overall lateral integrity of the isolator. For example, in the case of a three parameter isolator including a fluid-containing bellows, the isolator break frequency may be favorably lowered, within certain limits, by reducing the wall thickness of the bellows to increase the bellows' axial compliance. However, to provide sub-hertz damping of low mass payloads, an extremely thin-walled bellows may be required (e.g., a bellows having a wall thickness on the order of a few thousands of an inch) thereby rendering the bellows highly difficult to manufacture and unable withstand mission requirements. Furthermore, while it may be possible to design active isolation systems that effectively isolate low mass payloads from sub-hertz vibrations, active isolation systems require additional components (e.g., controllers, power sources, actuators, and the like), which add undesired bulk, weight, complexity, and cost to the isolation system.

It is thus desirable to provide embodiments of low frequency isolation device suitable for employment within a spacecraft isolation system capable of damping vibrations transmitted from a spacecraft to a low mass payload at relatively low (e.g., sub-hertz) frequencies. Ideally, embodiments of such a low frequency isolation device would be compact and lightweight and would permit independent tuning of axial and lateral stiffnesses and damping characteristics. It would also be desirable if embodiments of such a low frequency precision isolation device were passive and included few, in any, sliding components to minimize or eliminate friction. Other desirable features and characteristics of embodiments of the present invention will become apparent from the subsequent Detailed Description and the appended Claims, taken in conjunction with the accompanying drawings and the foregoing Background.

### BRIEF SUMMARY

Embodiments of a low frequency isolation device are provided. In one embodiment, the low frequency isolation device includes a three parameter isolator and a break frequency-reducing series spring mechanically coupled in series with the three parameter isolator and having a predetermined axial stiffness (K_{S AXIAL}) and a predetermined lateral stiffness (K_{S LATERAL}). The predetermined axial stiffness (K_{S AXIAL}) of the break frequency-reducing series spring is less than the predetermined lateral stiffness (K_{S LATERAL}) thereof.

Embodiments of a spacecraft isolation system are further provided for isolating a payload carried by a spacecraft. In one embodiment, the spacecraft isolation system includes a plurality of low frequency vibration isolators and plurality of payload attachment pieces, which are coupled to the plurality of low frequency isolation devices and configured to join the plurality of low frequency isolation devices to the payload in a multi-point mounting arrangement. Each low frequency isolation device includes a three parameter isolator and a break frequency-reducing series spring mechanically coupled in series with the three parameter isolator and having a predetermined axial stiffness (K_{S AXIAL}) and a predetermined lateral stiffness (K_{S LATERAL}). The predetermined axial stiffness (K_{S AXIAL}) of the break frequency-reducing series spring is less than the predetermined lateral stiffness (K_{S LATERAL}) thereof.

### BRIEF DESCRIPTION OF THE DRAWINGS

At least one example of the present invention will hereinafter be described in conjunction with the following figures, wherein like numerals denote like elements, and:

FIG. 1 is simplified schematic of a spacecraft isolation system employing eight low frequency isolation devices suitable for isolating a low mass payload from low frequency vibrations in six degrees of freedom in accordance with an exemplary embodiment of the present invention;

FIG. 2 is a schematic of an exemplary three parameter vibration isolator illustrated in accordance with the teachings of prior art;

FIG. 3 is a transmissibility plot of frequency (horizontal axis) versus gain (vertical axis) illustrating the transmissibility profile of the three parameter isolator shown in FIG. 2 as compared to the transmissibility profiles of a two parameter isolator and an undamped device;

FIG. 4 is a schematic of an exemplary low frequency isolation device suitable for usage as one or all of the isolation devices shown in FIG. 1;

FIG. 5 is a simplified cross-sectional view of a low frequency isolation device suitable for inclusion within the spacecraft isolation system shown in FIG. 1 and illustrated in accordance with a further exemplary embodiment of the present invention; and

FIG. 6 is a top-down view of an exemplary diaphragm spring that may be employed within the low frequency isolation device shown in FIG. 5.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description.

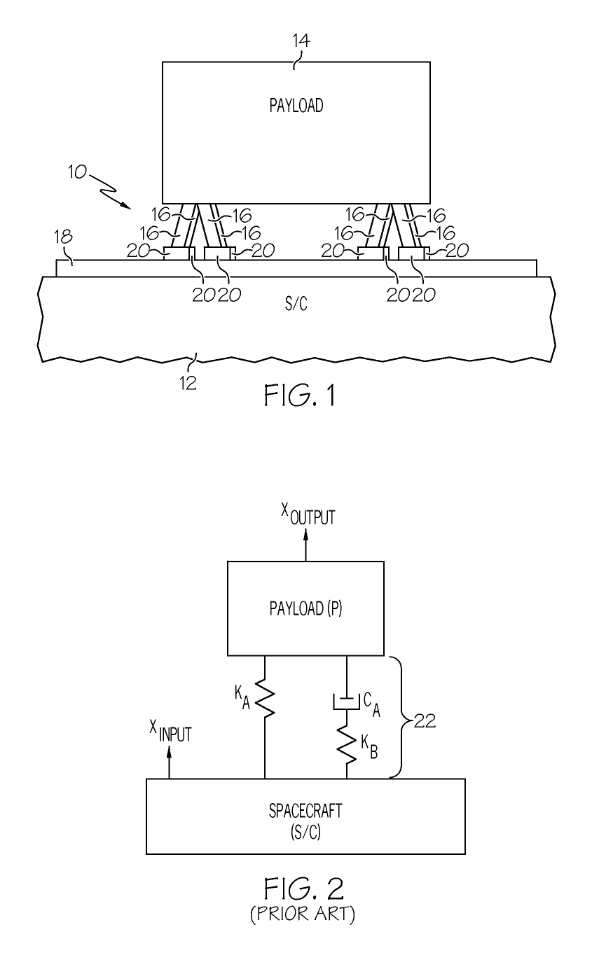

FIG. 1 is simplified schematic of a spacecraft isolation system 10 illustrated in accordance with an exemplary embodiment of the present invention and well-suited for reducing the transmission of vibrations from a spacecraft 12, such as a satellite, to a low mass payload 14 carried by spacecraft 12. Isolation system 10 includes a plurality of low frequency isolation devices 16, which are mechanically coupled to and collectively support payload 14. The opposing ends of low frequency isolation devices 16 are mounted to a spacecraft mounting interface 18 utilizing a plurality of mounting brackets 20. Low frequency isolation devices 16 are single degree-of-freedom dampers, which each provide damping in an axial direction. Low frequency isolation devices 16 are positioned in a multi-point mounting arrangement. In this particular example, isolation system 10 includes eight isolation devices 16, which are positioned in an octopod mounting arrangement to provide high fidelity damping in six degrees of freedom (“6-DOF”). In further embodiments, isolation system 10 may include a lesser number or a greater number of isolation devices, which may be positioned in other mounting arrangements. For example, in an alternative embodiment, isolation system 10 may include six low frequency isolation devices 16 positioned in a hexapod or Stewart platform-type mounting arrangement.

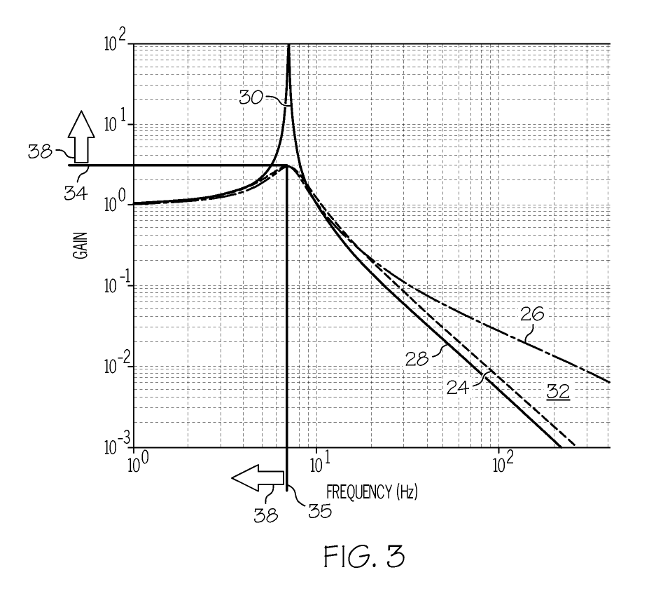

Low mass payload 14 may assume the form of any vibration-sensitive component, such as an optical payload or sensor suite, having a relatively low grounded or non-space-borne weight; e.g., low mass payload 14 may weigh less than about 20 pounds and possibly less than about 5 pounds when grounded. By comparison, many other types of payloads (e.g., reactions wheel and control moment gyroscope arrays) have weights well-exceeding 100 pounds when grounded. In one specific embodiment, low mass payload 14 is a laser communication system suitable for interplanetary communication. Due to the low mass of payload 14 and the fine pointing accuracies that may be required to ensure proper operation of payload 14, it is desirable to isolate payload 14 from low frequency vibrations emitted by or transmitted through spacecraft 12. It is also desirable that any multi-point isolation system utilized to isolate low mass payload 14 from such vibrations is relatively compact, lightweight, and preferably (although not necessarily) passive in design. As described in the foregoing section entitled “BACKGROUND,” three parameter isolators have been developed that provide superior damping performance as compared to other types of passive damping devices, such as viscoelastic elements. However, as described more fully below in conjunction with FIGS. 2 and 3, conventional three parameter isolators are typically incapable of providing adequate vibration attenuation at exceptionally low (e.g., sub-hertz) frequencies when utilized to support a low mass payload, such as payload 14 shown in FIG. 1.

FIG. 2 is a schematic representation of an exemplary three parameter isolator 22 mechanically coupled between a payload “P” and a spacecraft “S/C” and illustrated in accordance with the teachings of prior art. As modeled in FIG. 2, three parameter isolator 22 includes the following mechanical elements or components: (i) a first spring component K_{A}, which is mechanically coupled between payload P and a host spacecraft S/C; (ii) a second spring component K_{B}, which is mechanically coupled between payload P and spacecraft S/C in parallel with first spring component K_{A}; and (iii) a damper C_{A}, which is mechanically coupled between payload P and spacecraft S/C in parallel with the first spring component K_{A} and in series with the second spring component K_{B}. Transmissibility of three parameter isolator 22 is expressed by the following equation:

$$T ( ω ) = \frac{{X}_{output} ( ω )}{{X}_{input} ( ω )} \qquad EQ . 1$$

wherein T(ω) is transmissibility, Xₒᵤₜₚᵤₜ(ω) is the output motion of payload P, and Xᵢₙₚᵤₜ(ω) is the input motion imparted to isolator 22 by spacecraft S/C.

FIG. 3 is a transmissibility plot illustrating the damping characteristics of three parameter isolator 22 (curve 24) as compared to a two parameter isolator (curve 26) and an undamped device (curve 28). As indicated in FIG. 3 at 30, the undamped device (curve 28) provides an undesirably high peak gain at a threshold frequency, which, in the illustrated example, is moderately less than 10 hertz. By comparison, the two parameter device (curve 26) provides a significantly lower peak gain at the peak frequency, but an undesirably gradual decrease in gain with increasing frequency after the threshold frequency has been surpassed (referred to as “roll-off”). In the illustrated example, the roll-off of the two parameter device (curve 26) is approximately 20 decibel per decade (“dB/decade”). Lastly, the three parameter device (curve 24) provides a low peak gain substantially equivalent to that achieved by the two parameter device (curve 26), as indicated in FIG. 3 by horizontal line 34, and further provides a relatively steep roll-off of about 40 dB/decade. The three parameter device (curve 24) thus provides a significantly lower transmissibility at higher frequencies, as quantified in FIG. 3 by the area 32 bounded by curves 24 and 26. By way of non-limiting example, further discussion of three parameter isolators can be found in U.S. Pat. No. 5,332,070, entitled “THREE PARAMETER VISCOUS DAMPER AND ISOLATOR,” issued Jan. 26, 1994; and U.S. Pat. No. 7,182,188 B2, entitled “ISOLATOR USING EXTERNALLY PRESSURIZED SEALING BELLOWS,” issued Feb. 27, 2007; both of which are assigned to assignee of the instant application. As gain decreases with increasing frequency after the threshold frequency has been surpassed for three parameter isolator 22 (curve 24), as well as for two parameter isolator (curve 26) and undamped device (curve 28), the peak damping frequency is commonly referred to (and will be referred to below) as the “break frequency.”

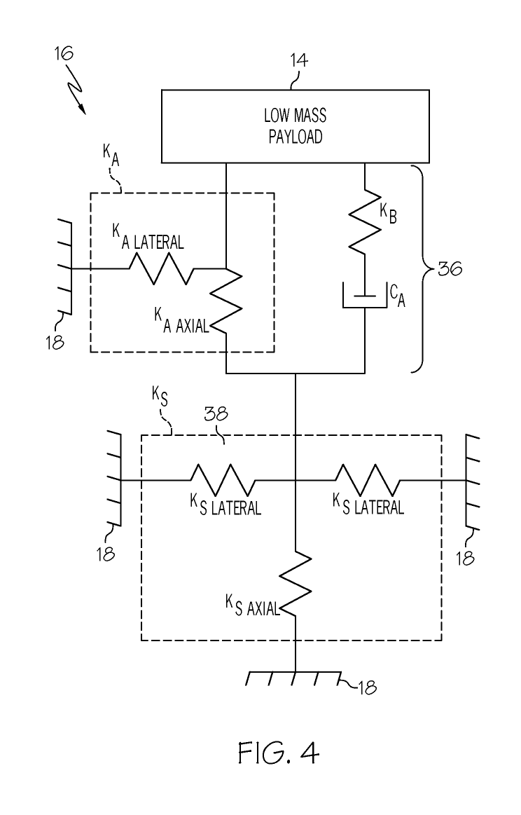

It can be seen in FIG. 3 that, while providing superior damping as compared to the two parameter isolator (curve 26) and the undamped device (curve 28), the conventional three parameter isolator 22 (curve 24) provides relatively little vibration attenuation at frequencies less than the break frequency (represented in FIG. 3 by vertical line 35). Thus, a 6-DOF isolation system employing three parameter isolator 22 in combination with other like isolators, will be substantially ineffective at isolating a lightweight or low mass payload, such as payload 14 shown in FIG. 1, from low frequency (e.g., sub-hertz) vibrations emitted by or transmitted through the host spacecraft. In contrast to such conventionally-produced three parameter isolators and other passive isolation devices, low frequency isolation devices 16 included within spacecraft isolation system 10 shown in FIG. 1 are each able to effectively attenuate low frequency vibrations transmitted from spacecraft 12 to lightweight payload 14. As a further advantage, each low frequency isolation device 16 is relatively compact, lightweight, and passive in design. The manner in which low frequency vibration isolators 16 are able to provide attenuation of such low frequency vibratory forces is described more fully below in conjunction with FIG. 4.

FIG. 4 is a schematic representation of a low frequency isolation device 16 included within spacecraft isolation system 10 shown in FIG. 1. As modeled in FIG. 4, three parameter isolator 36 includes the same mechanical elements or components as does conventional three parameter isolator 22 described above in conjunction with FIGS. 2 and 3. More specifically, three parameter isolator 36 includes: (i) a first spring component K_{A}, which is coupled between low mass payload 14 and spacecraft mounting structure 18 of spacecraft 12 (FIG. 1); (ii) a second spring component K_{B}, which is coupled between low mass payload 14 and spacecraft mounting structure 18 in parallel with first spring component K_{A}; and (iii) a damper C_{A}, which is coupled between payload 14 and spacecraft mounting structure 18 in parallel with the first spring component K_{A} and in series with the second spring component K_{B}. As will be described more fully below, low frequency isolation device 16 is implemented such that the axial stiffness of the first spring component K_{A} is less, and preferably significantly less, than the first spring component's lateral stiffness, as taken in all radial directions. Thus, for convenience of reference, spring component K_{A} is further shown in FIG. 4 as having a predetermined lateral stiffness K_{A LATERAL} and a predetermined axial stiffness K_{A AXIAL}.

Spring element 38 is mechanically coupled between low mass payload 14 and spacecraft mounting structure 18 in series with three parameter isolator 36. As indicated in FIG. 4, spring element 38 can be mechanically coupled between spacecraft mounting structure 18 and an end of three parameter isolator 36 substantially opposite payload 14. Alternatively, spring element 38 can be coupled between payload 14 and an end of three parameter isolator 36 substantially opposite spacecraft mounting structure 18. As will be explained more fully below, spring element 38 serves to decrease the break frequency of isolation device 16. Spring element 38 is thus referred herein as “break frequency-reducing series spring 38” or, more simply, as “series spring 38.” As was the case with first spring component K_{A}, and as further schematically represented in FIG. 4, break frequency-reducing series spring 38 has a predetermined axial stiffness (K_{S AXIAL}) that is less than, and preferably significantly less than the first spring component's lateral stiffness (K_{S LATERAL}), as taken in all radial directions.

In view of its considerable axial compliance, series spring 38 enables relative movement between the host spacecraft and low mass payload 14 at small axial displacements and low frequencies. At the same time, the relatively high lateral stiffness of series spring 38 prevents isolator buckling to help maintain the lateral integrity of isolation device 16. It will be appreciated that positioning an axially-soft spring in series with three parameter isolator 36 in this manner will detract from the overall performance of three parameter isolator 36. The present inventors have determined, however, that three parameter isolator 36 can be designed to still contribute appreciable damping, providing that the axial stiffness of the first spring component (K_{A AXIAL}) is tuned to be within a certain range of the series spring axial stiffness (K_{S AXIAL}); e.g., K_{A AXIAL} preferably differs from K_{S AXIAL} by a factor of less than two and, more preferably, is substantially equivalent to K_{S AXIAL}. Thus, as indicated in FIG. 3 by arrows 38, a tradeoff can be realized wherein the break frequency of isolation device 16 is reduced while the overall transmissibility over the operative frequency range is increased. In the case of conventional payloads having moderate to high masses, such a tradeoff may be undesirable. However, in the case of low mass payloads, such as low mass payload 14 shown in FIG. 1, an isolation device taking advantage of such a tradeoff may still provide appreciable damping at sub-hertz frequencies at which conventional three parameter isolators and other passive isolators provide little to no appreciable damping. Thus, when such a low frequency isolation device are combined with other such isolation devices in a multi-point isolation system (e.g., spacecraft isolation system 10 shown in FIG. 1), a low mass payload can be effectively isolated from low frequency vibrations to achieve high precision pointing accuracies that were previously unattainable utilizing conventional passive isolation systems.

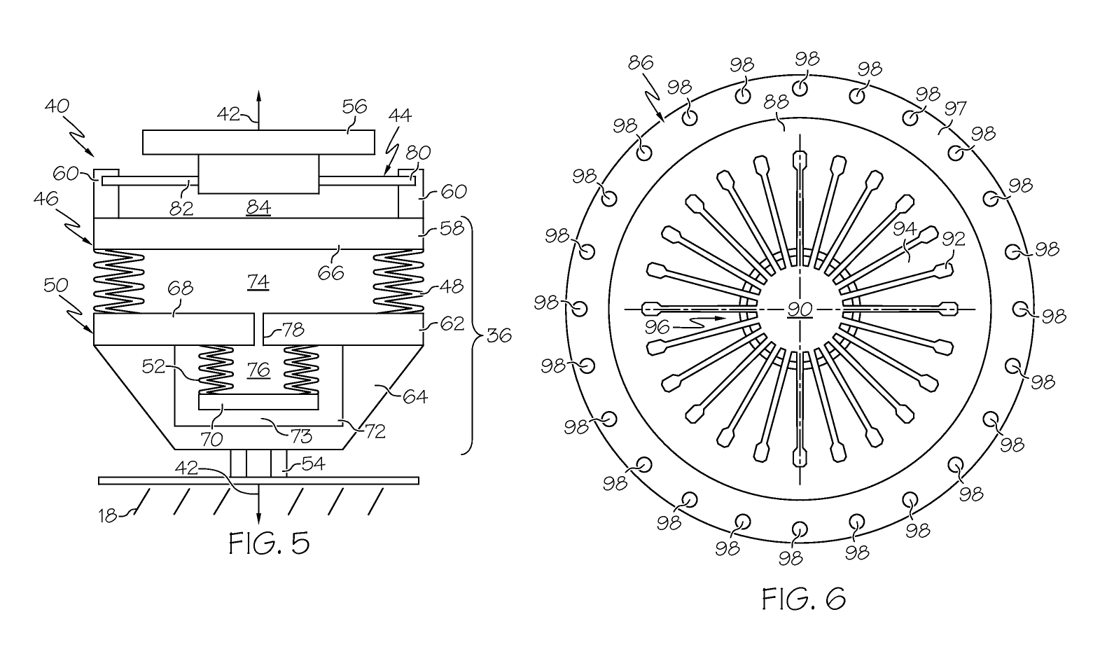

As noted above, series spring 38 has a relatively high lateral stiffness (K_{S LATERAL}) as compared to the axial stiffness thereof (K_{S AXIAL}) to prevent isolator buckling and thereby ensure that the lateral integrity of isolation device 16 is maintained. Similarly, first spring component K_{A} has a predetermined lateral stiffness (K_{A LATERAL}) that is significantly greater than the axial stiffness (K_{A AXIAL}) thereof to further prevent isolator buckling. In preferred embodiments, K_{S LATERAL} is at least ten times K_{S AXIAL}, and/or K_{A LATERAL} is at least ten times K_{A AXIAL}. Designing an isolation device having such high lateral-to-axial stiffness ratios, while also imparting the isolation device with a relatively low weight and compact envelope is highly difficult. An exemplary embodiment of one manner in which low frequency isolation device 16 can be structurally implemented in a lightweight and compact package is described below in conjunction with FIGS. 5 and 6.

FIG. 5 is a simplified cross-sectional view of a low frequency isolation device 40, which is illustrated in accordance with an exemplary embodiment of the present invention and which is suitable for usage as one or all of the low frequency isolation devices 16 included within spacecraft isolation system 10 shown in FIG. 1 and schematically represented in FIG. 4. In the exemplary embodiment shown in FIG. 5, low frequency isolation device 40 includes the following components (from top to bottom): (i) a diaphragm spring 44, (ii) a spring support structure 46, (iii) a primary bellows 48, (iv) a bellows support structure 50, and (v) a secondary bellows 52. Low frequency isolation device 40 is mechanically coupled between a payload (e.g., low mass payload 14 shown in FIGS. 1 and 4) and a host spacecraft (e.g., spacecraft 12 shown in FIG. 1) via spacecraft mounting interface 18. In the illustrated example, specifically, a first end of low frequency isolation device 40 (in particular, a terminal end of bellows support structure 50) is attached to a spacecraft mounting interface 18 through a pivotal coupling 54 (e.g., a blade flexure); while the second, opposing end of isolation device 40 (in particular, an inner circumferential portion of diaphragm spring 44) is attached to the non-illustrated low mass payload through a payload attachment piece 56. This example notwithstanding, the orientation of low frequency isolation device 40 may be inverted in alternative embodiments such that bellows support structure 50 is mechanically coupled most directly to the non-illustrated payload, while diaphragm spring 44 is coupled most directly to the host spacecraft.

Spring support structure 46 includes a bellows plate 58 and an annular lip or rim 60, which is affixed to bellows plate 58 and which extends axially therefrom toward diaphragm spring 44 and payload attachment piece 56. Similarly, bellows support structure 46 includes a bellows plate 62 and a base piece 64, which extends axially from bellows plate 62 away from primary bellows 48, away from spring support structure 46, and toward the host spacecraft. For ease of reference, bellows plate 58 and bellows plate 62 will be referred hereafter to as “upper bellows plate 58” and “lower bellows plate 62,” respectively, due to their exemplary orientation shown in FIG. 5; however, it will be appreciated that the illustrated orientation is arbitrary and is offered by way of non-limiting example only. Primary bellows 48 is sealingly joined between upper bellows plate 58 and lower bellows plate 62. For example, as shown in FIG. 5, a first end of primary bellows 48 (the upper end of bellows 48 in the illustrated orientation) may be joined to an outer annular region of the inner radial face 66 of upper bellows plate 58; while the second, opposing end of bellows 48 (the lower end of bellows 48 in the illustrated orientation) may be joined to an outer annular region of the inner radial face 68 of inner bellows plate 58.

A first end of secondary bellows 52 (the upper end of bellows 52 in the illustrated orientation) is sealingly joined to lower bellow plate 62 substantially opposite primary bellows 48; while the second, opposing end of secondary bellows (the lower end of bellows 52 in the illustrated orientation) is sealingly joined to a free-floating end plate 70. Secondary bellows 52 and primary bellows 48 are thus partitioned or separated by intervening bellows plate 62 of bellows support structure 50. Secondary bellows 52 may be at least partially surrounded by axially-extending base piece 64 of bellows support structure 50. For example, as shown in FIG. 5, secondary bellows 52 may be received within a cavity 72 provided within axially-extending base piece 64, while an axial clearance 73 is provided between the interior of base piece 64 defining cavity 72 and end plate 70 to accommodate expansion of bellows 52. Bellows 48 and 52 are substantially co-axial with one another and with the working axis 42 of low frequency isolation device 50. Bellows 48 and 52 are conveniently, although not necessarily, fabricated from a high temperature metal or alloy. Bellows 48 and 52 can be joined to the above-listed components of isolation device 40 utilizing any technique or means suitable for forming a fluid-tight or hermetic seal including, for example, a circumferential welding or bonding technique. Although internally pressurized in the exemplary embodiment shown in FIG. 5, bellows 48 and 52 can be externally pressurized in further embodiments.

Primary bellows 48, upper bellows plate 58, and lower bellows plate 62 define a first variable hydraulic chamber 74 within low frequency isolation device 16; while secondary bellows 52, lower bellows plate 62, and free-floating end plate 70 define a second variable hydraulic chamber 76. Prior to operation of low frequency isolation device 16, hydraulic chambers 74 and 76 are filled with a damping fluid, such as a silicone-based liquid. A fill port (not shown) may be provided through upper bellows plate 58, lower bellows plate 62, or end plate 70 to enable hydraulic chambers 74 and 76 to be filled with damping fluid after assembly of isolation device 16. After filling of hydraulic chambers 74 and 76, the fill port may be permanently sealed by, for example, deforming a sealing element (e.g., a copper ball) positioned within the fill port flow passage. If desired, low frequency isolation device 16 may also be equipped with a thermal compensation port, such as a spring loaded piston (not shown), in fluid communication with hydraulic chambers 74 and 76. A damping fluid annulus 78 is provided through lower bellows plate 62 to permit fluid communication between hydraulic chambers 74 and 76 and, specifically, to permit the exchange of damping fluid between hydraulic chambers 74 and 76 as primary bellows 48 expands and contracts in conjunction with relative axial movement of support structures 46 and 50 (described below). As appearing herein, the term “damping fluid annulus” denotes any opening, orifice, or flow passage through which damping fluid may flow between at least two hydraulic chambers.

An outer circumferential portion 80 of diaphragm spring 44 is affixed to rim 60, and an inner circumferential portion 82 of diaphragm spring 44 is affixed to payload attachment piece 56. Diaphragm spring 44 may be affixed to rim 60 and payload attachment piece 56 utilizing any suitable joinder technique (e.g., welding) or hardware (e.g., a plurality of bolts or other such fasteners). Diaphragm spring 44 thus extends radially inward from rim 60 toward working axis 42 to be joined to payload attachment piece 56. Rim 60 can be an axially-extending annular structure (e.g., a continuous circular ridge) or group of structures (e.g., a plurality of angularly spaced protrusions or castellations) to which an outer circumferential portion 80 of diaphragm spring 44 can be secured. Rim 60 defines a cavity or recess 84 within spring support structure 46, which provides a sufficient axial and radial clearances to ensure that contact does not occur between bellows plate 58 and payload attachment piece 56 during deflection of diaphragm spring 44.

FIG. 6 is a top-down view of diaphragm spring 44 in accordance with an exemplary embodiment. Diaphragm spring 44 includes central disc-shaped body 88 having a central opening 90 and a plurality of radial slits 92 (only one of which is labeled in FIG. 6). Radial slits 92 collectively define a plurality of elongated, tapered fingers 94 (again, only one of which is labeled in FIG. 6), which extend radially inward toward a central portion 96 of spring body 88 to promote axial deflection of spring body 88 and, specifically, axial displacement of central portion 96 of body 88 relative to the outer circumferential portion thereof. In so doing, radial fingers 94 impart diaphragm spring 44 with a predetermined axial stiffness, which is significantly less than the lateral stiffness of spring 86. The outer diameter of diaphragm spring 44 is closer to the outer diameter of primary bellows 48 than to the outer diameter of secondary bellows 52; e.g., in one embodiment, the outer diameter of diaphragm spring 44 may be substantially equivalent to the outer diameter of primary bellows 48. Such a structural configuration enables diaphragm spring 44 to axially deflect under low frequency conditions, while preserving the lateral integrity of low frequency isolation device 40. To facilitate attachment of diaphragm spring 44 to axially-extending rim 60 of spring support structure 46, diaphragm spring 44 may also be fabricated to include an outer circumferential flange 97 through which a plurality of fastener openings 98 are provided. The foregoing notwithstanding, any pattern or design can be created within the spring body (e.g., a spiral pattern) suitable for imparting the diaphragm spring with the above-described characteristics.

In the illustrated example, and referring once again to FIG. 5, spring support structure 46 and bellows support structure 50 are joined solely or exclusively by primary bellows 48. Consequently, spring support structure 46 and bellows support structure 50 are permitted to move relative to one another (i.e., axially converge or diverge) along working axis 42 with deflection of primary bellows 48. Primary bellows 48 thus compresses and expands to accommodate relative movement between bellows support structure 50 and spring support structure 46. Secondary bellows 52 compresses and expands, as needed, to receive damping fluid from and supply damping fluid to primary bellows 48 through damping fluid annulus 78. Damping is provided by viscous fluid losses as damping fluid is forced through annulus 78. Collectively, bellows 48, bellows 52, annulus 78, hydraulic chambers 74 and 76 and the damping fluid contained therein, spring support structure 46, and spring support structure 50 function as three parameter isolator 36 wherein: K_{A} is generally determined by primary bellows 48; K_{B} is generally determined by the volumetric stiffness of the previously-listed components; and C_{A} is generally determined by the damper rate of damper formed by bellows 48, bellows 52, annulus 78, hydraulic chambers 74 and 76 and the damping fluid contained therein. Furthermore, in keeping with the terminology above and the exemplary schematic shown in FIG. 4, K_{A LATERAL} and K_{A AXIAL} are determined by the lateral and axial stiffnesses, respectively, of primary bellows 48.

As noted above, K_{A LATERAL} is selected to be greater than and, preferably, at least ten times K_{A AXIAL}. In the exemplary structural implementation shown in FIG. 5, this is accomplished, at least in part, by imparting primary bellows 48 with a large outer diameter by sealingly coupling the opposing circumferential edges of bellows 48 to the outer annular regions of the inner faces of bellows plates 58 and 62. In general, it is preferred that the outer diameter of primary bellows 48 is greater than at least one half of the maximum outer diameter of low frequency isolation device 40 and, more preferably, substantially equivalent to the maximum outer of isolation device 40. As appearing herein, the term “substantially equivalent” denotes a disparity in magnitude of less than about 10%. In further embodiments, the outer diameter of bellows 48 is substantially equivalent to the outer diameter of bellows plate 58 and/or bellows plate 62. Notably, K_{A LATERAL} and K_{A AXIAL} can be tuned, within certain limits, by adjusting the lateral and axial stiffnesses of primary bellows 48, respectively, through modifications in dimensions (e.g., wall thickness and outer diameter), materials, and other parameters. The damper rate C_{A} of three parameter isolator 36 can also be independently tuned by altering the dimensions of hydraulic chambers 74 and 76, the dimensions and/or number of damping fluid annuli 78, the damping fluid composition, and so on.

In the exemplary embodiment shown in FIG. 5, diaphragm spring 44 serves as break frequency-reducing series spring 38 schematically shown in FIG. 4; that is, diaphragm spring 44 is mechanically coupled in series with the three parameter isolator 36, while having an axial compliancy sufficient to reduce the break frequency of isolation device 40 as previously described. Diaphragm spring 44 also has a relatively high lateral stiffness (K_{S LATERAL}) to preserve the overall lateral integrity of isolation device 40. As may be appreciated by referring to FIGS. 5 and 6, diaphragm spring 44 is imparted with such a high lateral-to-axial stiffness ratio in view of its axially-thin, radially-elongated form; its orthogonal disposition with respect to working axis 42; and its spring pattern or design formed by cut-outs or other such openings. Notably, the lateral stiffness (K_{S LATERAL}) and axial stiffness (K_{S AXIAL}) of series spring 44 can also be tuned by adjusting the axial thickness of spring 44, the spring design (e.g., the number, dimension, and pattern of cut-outs), and the like. The foregoing notwithstanding, it is emphasized that other resilient elements or groupings and assemblages of elements can be employed as the break frequency-reducing spring in alternative embodiments, providing that such resilient element(s) are positioned around working axis of the isolation device and characterized by a relatively high radial-to-axial stiffness ratio. For example, in further embodiments, the break frequency-reducing series spring may assume the form of a plurality of (e.g., three to four) elongated flexures or beams angularly spaced about working axis of the isolation device and extending radially outward therefrom in, for example, a star flexure configuration. Diaphragm spring 44 and primary bellows 48 also preferably each have a relatively high torsional stiffness to prevent undesired twisting of low frequency isolation device 40 about working axis 42.

The foregoing has thus provided embodiments of low frequency isolation device suitable for employment within a spacecraft isolation system and capable of damping vibrations transmitted from a spacecraft to a low mass payload at relatively low (e.g., sub-hertz) frequencies. Advantageously, embodiments of the above-described low frequency isolation device are compact and lightweight; are frictionless (i.e., lack sliding parts); and enable the axial and lateral stiffnesses and damping characteristics of the isolation device to be independently tuned. Furthermore, the above-described exemplary low frequency isolation devices are passive and consequently do not require the additional structural components required by active damping systems. This notwithstanding, in instances wherein it is acceptable to increase system complexity, part count, and cost, the damping performance of embodiments of the above-described spacecraft isolation system can be improved by further pairing embodiments of the low frequency isolation device with known active control systems, such as voice coils.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended claims.

What is claimed is:

1. A low frequency isolation device, comprising:
a three parameter isolator; and
a break frequency-reducing series spring mechanically coupled in series with the three parameter isolator and having a predetermined axial stiffness (K_{S AXIAL}) and a predetermined lateral stiffness (K_{S LATERAL}), the predetermined axial stiffness (K_{S AXIAL}) of the break frequency-reducing series spring being less than the predetermined lateral stiffness (K_{S LATERAL}) thereof.

2. A low frequency isolation device according to claim 1 wherein the three parameter isolator comprises a primary bellows having predetermined axial stiffness (K_{A AXIAL}) and a predetermined lateral stiffness (K_{A LATERAL}), the predetermined axial stiffness (K_{A AXIAL}) of the primary bellows being less than the predetermined lateral stiffness (K_{A LATERAL}) thereof.

3. A low frequency isolation device according to claim 2 wherein the outer diameter of the primary bellows is greater than half the maximum outer diameter of the low frequency isolation device.

4. A low frequency isolation device according to claim 3 wherein the outer diameter of the primary bellows is substantially equal to the maximum outer diameter of the low frequency isolation device.

5. A low frequency isolation device according to claim 2 wherein the three parameter isolator further comprises:
a spring support structure; and
a bellows support structure movably coupled to the spring support structure through the primary bellows.

6. A low frequency isolation device according to claim 5 wherein the break frequency-reducing series spring is coupled to the spring support structure substantially opposite the primary bellows.

7. A low frequency isolation device according to claim 6 wherein an outer circumferential portion of the break frequency-reducing series spring is affixed to the spring support structure.

8. A low frequency isolation device according to claim 6 wherein the bellows support structure comprises a bellows plate to which the primary bellows is sealingly coupled.

9. A low frequency isolation device according to claim 8 further comprising:
a secondary bellows sealingly coupled to the bellows plate substantially opposite the primary bellows; and
an annulus formed through the bellows plate fluidly coupling the primary bellows and the secondary bellows.

10. A low frequency isolation device according to claim 8 wherein the outer diameter of the primary bellows is substantially equivalent to the outer diameter of the bellows plate.

11. A low frequency isolation device according to claim 5 wherein spring support structure comprises an axially-extending rim to which the break frequency-reducing series spring is joined, the break frequency-reducing series spring extending radially inward from the axially-extending rim toward the working axis of the low frequency isolation device.

12. A low frequency isolation device according to claim 2 wherein the predetermined axial stiffness (K_{S AXIAL}) of the break frequency-reducing series spring is less than twice the predetermined axial stiffness (K_{A AXIAL}) of the primary bellows.

13. A low frequency isolation device according to claim 12 wherein the predetermined axial stiffness (K_{S AXIAL}) of the break frequency-reducing series spring is at least ten times less than the predetermined lateral stiffness (K_{S LATERAL}) thereof.

14. A low frequency isolation device according to claim 12 wherein the predetermined axial stiffness (K_{A AXIAL}) of the primary bellows is at least ten times less than the predetermined lateral stiffness (K_{A LATERAL}) thereof.

15. A low frequency isolation device according to claim 1 wherein the break frequency-reducing series spring is positioned substantially orthogonal to the working axis of the low frequency isolation device.

16. A low frequency isolation device according to claim 5 wherein the break frequency-reducing series spring comprises a diaphragm spring.

17. A low frequency isolation device, comprising:
a three parameter isolator, comprising:
a primary bellows circumferentially bounding a first hydraulic chamber;
a secondary bellows circumferentially bounding a second hydraulic chamber; and
an annulus fluidly coupling the primary bellows and the secondary bellows to allow damping fluid flow between the first and second variable chambers in conjunction with deflection of the primary and secondary bellows; and
a break frequency-reducing series spring in series with the three parameter isolator and having predetermined axial and lateral stiffnesses, the predetermined axial stiffness of the break frequency-reducing series spring being less than the predetermined lateral stiffness thereof.

18. A low frequency isolation device according to claim 17 further comprising:
a spring support structure to which the break frequency-reducing series spring is coupled; and
a bellows support structure movably coupled to the spring support structure by the primary bellows.

19. A low frequency isolation device according to claim 17 wherein primary bellows is sealingly coupled between an outer annular region of the spring support structure and an outer annular region of the bellows support structure.

20. A spacecraft isolation system suitable for isolating a payload carried by a spacecraft, the spacecraft isolation system comprising:
a plurality of low frequency vibration isolators, each comprising:
a three parameter isolator; and
a break frequency-reducing series spring mechanically coupled in series with the three parameter isolator and having a predetermined axial stiffness (K_{S AXIAL}) and a predetermined lateral stiffness (K_{S LATERAL}), the predetermined axial stiffness (K_{S AXIAL}) of the break frequency-reducing series spring being less than the predetermined lateral stiffness (K_{S LATERAL}) thereof; and
a plurality of payload attachment pieces coupled to the plurality of low frequency isolation devices and configured to join the plurality of low frequency isolation devices to the payload in a multi-point mounting arrangement.
